(19) United States
(12) Patent Application Publication
(10) Pub. No.: US 2004/0047714 A1
(43) Pub. Date: Mar. 11, 2004

(54) System for the conveying and storage of containers of semiconductor wafers, and transfer mechanism

(75) Inventors: Bernard Poli, Cox (FR); Alain Gaudon, Launac (FR); Christophe Lero, Leguevin (FR); Florent Haddad, Seilh (FR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Recif, Societe Anonyme, Aussone (FR)

(21) Appl. No.: 10/655,701

(22) Filed: Sep. 5, 2003

(30) Foreign Application Priority Data
Sep. 6, 2002 (FR) 211049

(51) Int. Cl. B65G 1/00

(52) U.S. Cl. 414/281

(57) ABSTRACT

A system for conveying and storing wafer containers in connection with wafer processing tools arranged in a row of a wafer fabrication facility and having substantially vertical faces in a common plane with wafer loading/unloading openings associated therewith includes a wafer container storage area, a wafer container temporary support, and a wafer container transfer mechanism. A row conveyor conveys wafer containers to the row. The wafer container transfer mechanism is located rearwardly of the vertical faces of the tools and the wafer container storage area, which has a plurality of stacked shelves, is located reawardly of the faces and above the tools in a subframe. The wafer container temporary support protrudes from the front of the faces. A wafer container transfer mechanism drive moves the wafer container transfer mechanism in X, Y, and Z directions in order to access the container storage area, the wafer container temporary support, and the openings of the tools. The wafer container transfer mechanism employs a wafer container grasping mechanism, a device for movement in the Y direction, and an elevator system for lowering and raising grasped containers from the openings of the tools in the row.

### BACKGROUND OF THE INVENTION

1. Field of the Invention

The present invention concerns the conveying and storage of containers of semiconductor wafers in semiconductor wafer manufacturing facilities, and more especially to an integrated system able to transfer and store containers of semiconductor wafers between semiconductor wafer processing tools arranged substantially in a row in a semiconductor wafer manufacturing facility.

2. Description of Related Art

Semiconductor wafers are conveyed and processed in wafer fabrication facilities under conditions that guarantee a clean environment, i.e., an environment in which the number and size of particles suspended in the air are strictly controlled using precise technologies. One such technology is referred to as SMIF (“Standard Mechanical Interface”) technology. With this aim, semiconductor wafers to be processed are placed in airtight containers. The containers carrying the wafers are conveyed within the fab to selected processing tools, where they are located proximate wafer-loading/unloading openings, which are located on the processing tools. The tools operate in their own contained, controlled atmosphere. Suitable robots are provided with the processing tools in order to transfer the wafers to be processed into the processing tools. A row of a wafer fab usually includes several wafer processing tools, including several wafer-loading/unloading openings. Wafer containers are conveyed from one row to another by means of a supply line or inter-row conveyor, usually using a suspended rail that moves above the wafer loading/unloading openings of the processing tools, and a lift that allows a container to be moved down and up in front of an opening, from the suspended rail. Wafers may be processed at different rates in various processing tools of a row, which creates problems for managing the efficient flow of containers in and between the rows and requires the use of buffer or temporary storage areas. Between a normal-processing-rate wafer tool and a low-processing-rate metrology tool, both of which may be located within the same row, there may be a difference in processing rate of about 25 containers per hour for each tool to maintain its optimal output.

The previous state-of-the-art teaches integrated systems that include temporary storage areas for containers, means of distribution of these containers between a container supply line, storage and temporary storage areas, and loading/unloading openings for the tools in a row of the fabrication facility.

One known system involves a front-row storage. The inter-row conveyor that links the rows to supply each of them with containers deposits containers on and withdraws containers from a storage unit located at the front of a row of processing tools. Then a conveyor internal to the row of tools accesses the containers that are present in the storage area and conveys them to the loading/unloading openings of the processing tools or to temporary buffer storage areas extending from the front face of the tools, i.e. extending outwardly from the front of a plane defined by the wafer-loading/unloading opening(s). When temporary storage areas are located on the front face of the tools, an additional container supplying mechanism internal to the tools is necessary to transport containers from the temporary storage area to the loading/unloading opening and vice-versa. The conveyor internal to the row of tools can no longer perform this function efficiently because of the congestion induced by the temporary storage area on the front face, which hampers the movements of the internal conveyor and prevents it from directly supplying the containers to the loading/unloading openings of the tools.

Alternatively, a container may be directly transferred from the inter-row conveyor to the row's internal conveyor without going through the front-row storage, to be then conveyed to the loading/unloading openings or to the temporary storage areas, as explained above. The row's internal conveyor may include a rail suspended above the loading/unloading openings of the tools and a combined lift to lower a container suspended from the rail in front of the loading/unloading opening of a tool. In such case, the vertical pathway between the rail and the loading/unloading opening(s) should remain free of obstructions. However, this is not the case when storage areas are set in the front face of the tools above the loading/unloading openings. In addition, the vertical lift cannot access containers located below containers on upper areas of the front face, hence the need for a specific additional device—often bulky—in order to convey the containers situated in lower temporary storage areas to the loading/unloading openings of the tools.

These storage area arrangements require a considerable amount of floor surface and the provision of specific means to access containers in the temporary storage areas, as well as the provision of specific additional devices for supplying containers to the storage areas and tools. Additionally, the complexity of these systems also increases the risk that mechanical breakdowns will occur and entail extra management costs. The breakdown of a container supplying mechanism specific to a tool results in the isolation of such tool and renders it impossible to supply it with wafer containers for processing. Moreover, it is worth recalling that the floor surface in semiconductor wafer fabrication facilities is extremely expensive considering the stringent cleanliness requirements in force.

U.S. Pat. No. 5,980,183 offers a solution that consists in suppressing conventional storage and temporary storage areas by creating an additional area within a row of tools without increasing the size of the row. The '183 patent suggests a container storage system generally located on the front face of the processing tools and above the wafer container loading/unloading openings. The storage system extends outwardly from the front face of the tools and the plane defined by the wafer-loading/unloading openings, and is likely to exceed the height of the tools, thus replacing the front row storage and front-face temporary storage areas which effected specific tools in the previous state-of-the-art. This mode of storage requires the existence of a shuttle that can access front-face storage shelves and an interface with the inter-row container-supply line. This shuttle consists of a device for handling mobile containers in translation according to two perpendicular axes, moving in the vertical plane in front of the storage shelves, and consequently in a vertical plane before the containers stored in the front face of the tools. The shuttle allows containers left by the inter-row supply line in the front of the row on appropriate shelves to be moved by the row's internal conveyor, therefore substituting the row's internal conveyor for the container conveying mechanism specific to each tool having a buffer storage, as in the previous state-of-the-art. This is a considerable simplification of the prior systems. However, the storage of containers in the front face of the tools, extending outwardly from the face, requires a conveying mechanism located further out in front of the containers stored. Consequently, such a storage system requires considerable area for its facilities, and therefore entails high manufacturing and running costs. Moreover, there is an increased risk of contamination in the openings between the storage shelves and the conveying mechanism located in front of and above the loading/unloading openings.

### BRIEF SUMMARY OF THE INVENTION

The present invention aims at reducing or eliminating such drawbacks. It consists in a system for conveying and storing semiconductor wafer containers, which is intended to be used in at least one row of a wafer fab. The row will include one or several semiconductor wafer processing tools each having a front face fitted with at least one wafer-loading/unloading opening, which is able to be associated with a semiconductor wafer container. The wafer-loading/unloading openings of the processing tool or tools are located substantially within a vertical plane, and the row is supplied with wafer containers by a row conveyor located above the processing tool or tools and parallel to the vertical plane.

The invention generally comprises a storage area for wafer containers located above the semiconductor wafer processing tool or tools in the row and set back from the wafer-loading/unloading openings; a temporary support for at least one container, the temporary support protruding from the front face of the processing tools, and being located at the base of the row conveyor, while leaving the area situated above the wafer-loading/unloading openings free of obstruction; a first transfer mechanism to move containers between the temporary support and the storage area; a second transfer mechanism to move containers between the storage area and the wafer-loading/unloading openings; and a third transfer mechanism to move containers between the temporary support and the wafer-loading/unloading openings.

According to an advantageous characteristic, the storage area includes several shelves situated in a volume wholly located above the semiconductor wafer processing tool or tools and rearward of the wafer-loading/unloading openings.

According to another advantageous characteristic, the storage shelves are stacked in multiple levels and extend substantially over the entire length of the row.

According to another advantageous characteristic, the storage area may include a sub-frame having an upper portion to which the storage shelves are fastened with the shelves being globally supported on the sub-frame, a floor located above the semiconductor wafer processing tool or tools, and pillars that extend to the ground to support the floor, the floor including a free area extending along the shelves and the row, thus allowing an operator to circulate freely. Alternatively, the storage area may be suspended above the level of the tool or tools without pillars.

According to another advantageous characteristic, the floor is adapted to provide vertical air circulation.

According to another advantageous characteristic, the first, second and third transfer mechanisms are integrated within a transfer mechanism that includes a container grasping mechanism, and a drive to move the container grasping mechanism in three directions in space, allowing the container grasping mechanism to access the wafer loading/unloading openings of the tool or tools, the storage shelves and the temporary support.

According to another advantageous characteristic, the drive has at least three degrees of freedom in translation corresponding to three perpendicular directions, i.e. X, Y, Z.

According to another advantageous characteristic, the transfer mechanism includes a first guide parallel to the row that provides one degree of freedom in translation corresponding to the X-direction, a second guide that provides one degree of freedom in translation corresponding to the Z-direction, and a trolley supporting the container grasping mechanism and guided in translation on the second guide, the container grasping mechanism being coupled to the trolley by a link having one degree of freedom in translation corresponding to the Y-direction. Alternatively, the transfer mechanism may include a pair of interconnected rotating arms to provide the necessary degree of freedom in the Y-direction.

According to another advantageous characteristic, the second guide is free to move in translation on the first guide.

According to another advantageous characteristic, the length of the first guide is approximately equal to the length of the row, and the height of the second guide is approximately equal to the height of the upper portion of the sub-frame.

According to another advantageous characteristic, the first and second guides are located rearwardly of the container loading/unloading openings of the semiconductor wafer processing tools in an area above the tools, and in front of the storage shelves.

According to another advantageous characteristic, the container grasping mechanism is also coupled to the trolley or rotating arms by a vertical elevator that enables the container grasping mechanism to move vertically to access an area beneath the trolley or rotating arms.

According to another advantageous characteristic, the link that couples the container grasping mechanism and the trolley or rotating arms comprises a device that enables container grasping mechanism to move in the Y-direction on both sides of the first and second guides.

According to another advantageous characteristic, the system includes a second drive to move the temporary support in order to maintain the area above the wafer-loading/unloading openings free of obstruction.

According to another advantageous characteristic, the second drive includes one degree of freedom in translation along the Y-axis to move the temporary support in the Y-direction between a first position in which it protrudes from the front face of the processing tool or tools and a second position in which it does not protrude from the front face.

The present invention also concerns a container transfer mechanism intended to be used in a system for conveying and storing semiconductor wafer containers in a row of a semiconductor wafer fab, where the row includes several semiconductor wafer processing tools each having a front face fitted with at least one wafer-loading/unloading opening, which is able to be associated with a semiconductor wafer container. The wafer-loading/unloading openings are arranged substantially in a vertical plane, and the row of wafer processing tools is supplied with containers by a row conveyor located above the processing tools and parallel to the vertical plane. The system includes a container storage area, a temporary support for at least one container. In this aspect of the invention, the container transfer mechanism includes a container grasping mechanism, and a drive to move the container grasping mechanism in three directions in space, i.e. X, Y, Z, thereby allowing the container grasping mechanism to access the wafer-loading/unloading openings of the tools, the container storage area, and the temporary support.

### BRIEF DESCRIPTION OF THE DRAWINGS

Other advantages and characteristics will appear upon reading the following detailed description of an exemplary implementation of a system for conveying and storing semiconductor wafer containers according to the invention, together with the drawings annexed. This example is given as an illustrative, non-restrictive embodiment, in which:

FIG. 1 represents a perspective view of an exemplary embodiment of a system according to the invention;

FIG. 2 represents a front view of the exemplary embodiment of FIG. 1;

FIG. 3 represents a top view of the exemplary embodiment of FIG. 1;

FIG. 4 represents a lateral view of the exemplary embodiment of FIG. 1;

FIG. 5 represents a perspective view of an enlarged detail of the exemplary embodiment of FIG. 1;

FIGS. 6A and 6B represent an enlarged detail of FIG. 5, in two different working positions, in bottom and perspective view respectively; and

FIG. 7 represents a schematic view in cross section along the Y-axis of the detail shown in FIGS. 6A and 6B.

FIG. 8 represents a perspective view of an alternative mechanism for grasping and conveying wafer containers, shown in a vertically extended position.

FIG. 9 represents a perspective view of the alternative mechanism for grasping and conveying wafer containers of FIG. 8, shown in a vertically retracted position.

### DETAILED DESCRIPTION OF THE INVENTION

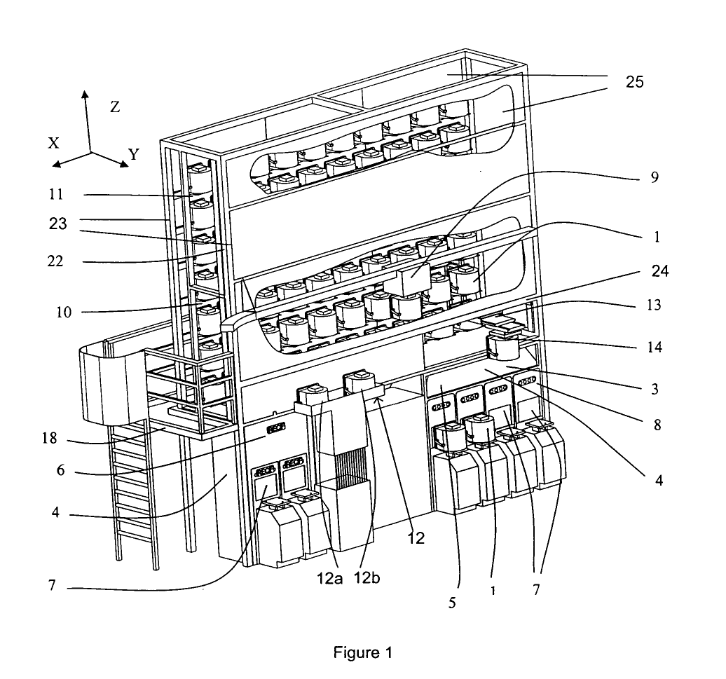

The exemplary system represented in FIG. 1 for conveying and storing containers 1 of semiconductor wafers (not shown) is intended to be used in at least one row 2 of a semiconductor wafer fabrication facility. The row represented in the example includes, for instance, four 300 mm-selector tools 3 for the processing of semiconductor wafers, and two tools 4 for metrological characterization. The wafer processing tools 3, 4 each have respective front faces 5, 6, with the front face of each tool being fitted with a wafer-loading/unloading opening 7 able to be associated with a container 1 including several semiconductor wafers to be processed. The wafer-loading/unloading openings of the processing tools are arranged substantially within a vertical plane 8, and the row 2 is supplied with containers by a row conveyor 9 located above the processing tools 3, 4 and parallel to the vertical plane 8, as represented in FIGS. 1, 3 and 4.

The exemplary system as represented in FIGS. 1 to 9 preferably includes a container storage area 10, which is located in an area 11 above the semiconductor wafer processing tools 3, 4, and which is set back rearwardly of the wafer- loading/unloading openings 7, and more particularly set back rearwardly of the vertical plane including the loading/unloading openings. FIG. 1 represents a front view of this exemplary system.

The exemplary system also preferably includes a temporary container support 12 for two containers 1. The container support provides respectively a first support for a container entering the container storage area 10, and a second support for a container exiting the container storage area. The temporary support 12 protrudes from the front face 5, 6 of the processing tools 3, 4, and is located at the base of the row conveyor 9. In the exemplary system, the temporary support 12 preferably protrudes from the front faces 5, 6 laterally of the wafer-loading/unloading openings 7 located on the processing tools, so as to maintain the area above the wafer-loading/unloading openings (7) free of obstruction.

The exemplary system also preferably includes an integrated container transfer mechanism 13. The integrated container transfer mechanism preferably includes a first container transfer mechanism that moves containers 1 between the temporary support 12 and the container storage area 10, a second container transfer mechanism that moves containers 1 between the container storage area 10 and the wafer-loading/unloading openings 7, and a third container transfer mechanism that moves containers 1 between the temporary support 12 and the wafer-loading/unloading openings 7.

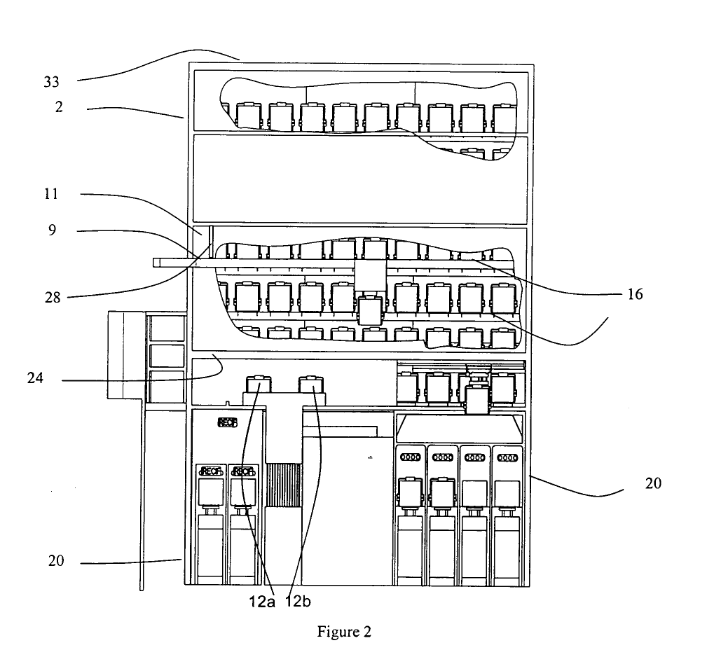

Please note that wafer processing tools 3 and 4 are not represented in FIGS. 2, 3 and 4 in order to simplify the drawings.

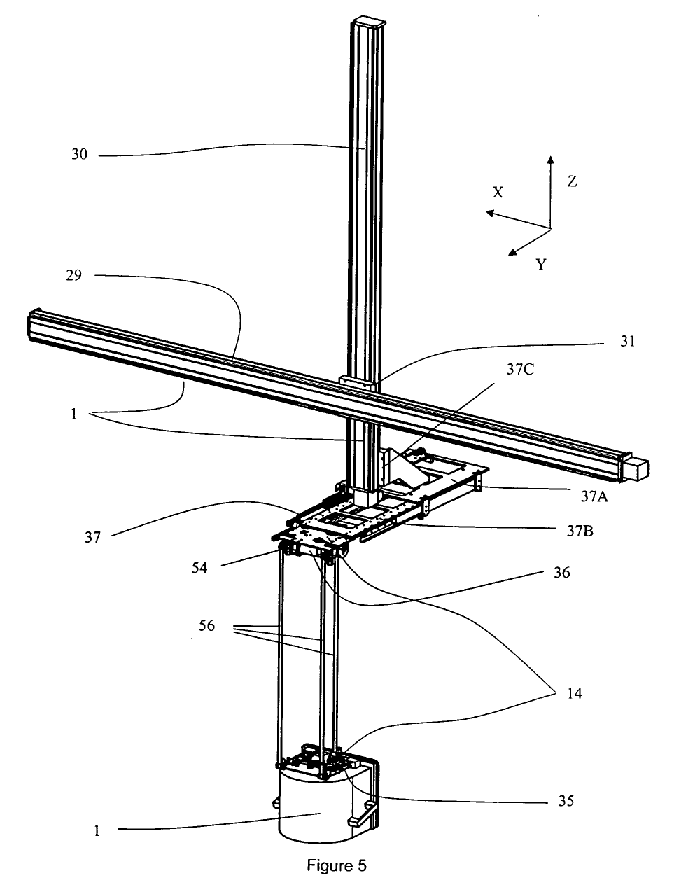

As more specifically represented in FIGS. 5 through 9, the first, second and third container transfer mechanisms are integrated in container transfer mechanism 13. The integrated container transfer mechanism preferably includes a container grasping mechanism 14, a drive 15 that moves the container grasping mechanism 14 in three directions in space X, Y, Z, thereby enabling the container grasping mechanism 14 to access the wafer loading/unloading openings 7 of the tools 3, 4, shelves 16 in the container storage area 10, and the temporary support 12. More detailed descriptions of preferred embodiments of the container transfer mechanism 13 are found below.

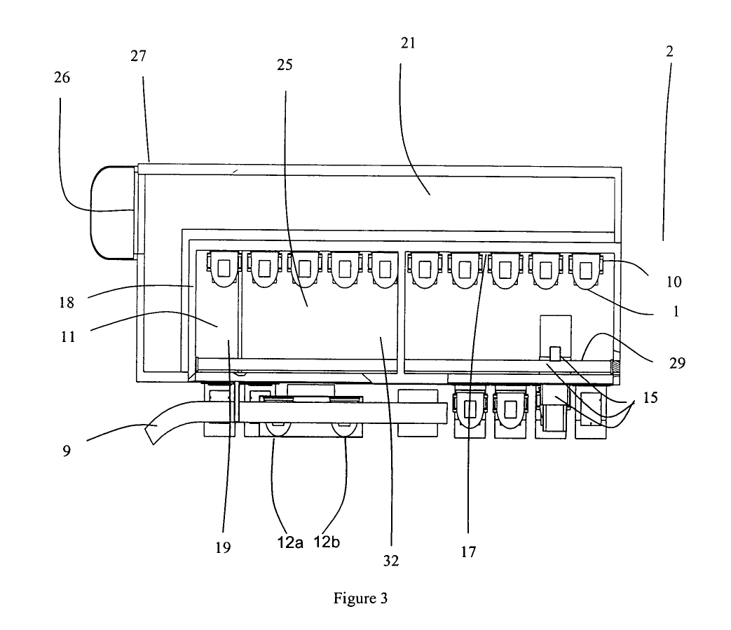

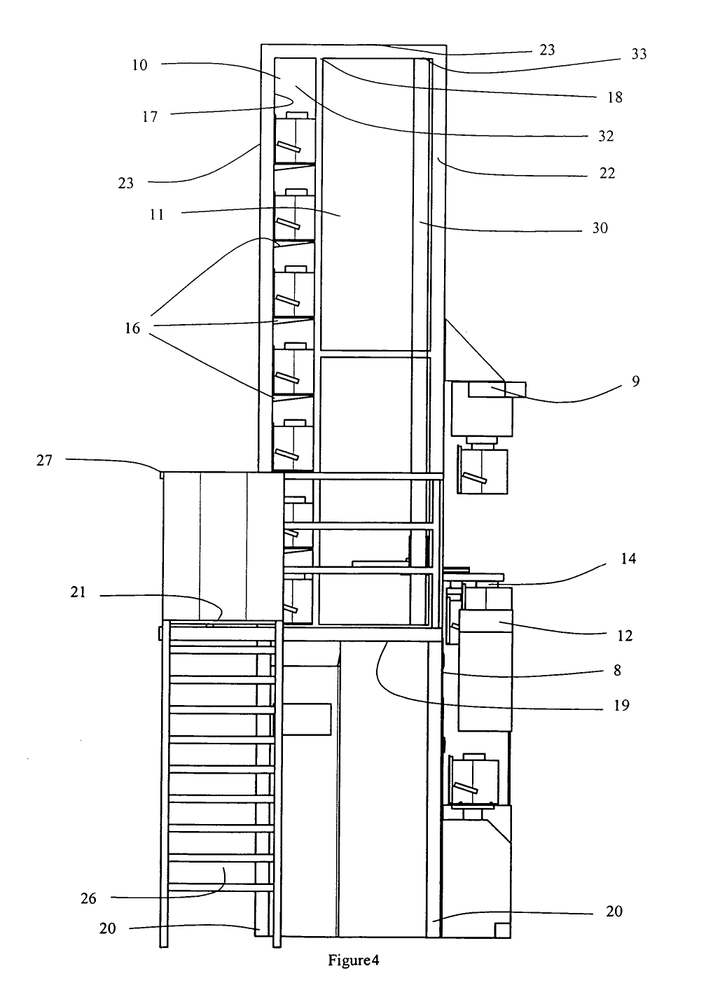

The container storage area 10 preferably includes a number of shelves 16 situated in a volume wholly located above the semiconductor wafer processing tools 3, 4 and set back rearwardly of the wafer-loading/unloading openings 7. As represented in FIGS. 3 and 4, the shelves 16 enable containers 1 to be stored substantially against a vertical plane 17 set back rearwardly from the vertical plane 8 that includes the openings 7. Preferably, the vertical plane 17 is set back at a distance greater than the dimension of a container 1 along the Y-axis, which is the width of the container 1. The shelves 16 may comprise, for instance, four vertically-stacked horizontal levels that preferably extend approximately along the entire length of the row 2 in order to use the maximum available space. Each shelf constitutes a level, which may be continuous or discontinuous and, in the exemplary system, enables nine containers 1 to be horizontally arrayed along its length. Of course, the maximum number of containers that can be arrayed along a level depends on the length of the row, and also the number of processing tools set in the row. The height of the container storage area 10 in the Z-direction is only limited by the available space in the fabrication facility above the tools. It therefore may be considered to build a greater number of shelf levels, up to the maximum admissible height according to the building that houses the row. The shelves preferably should permit free front access to each of the containers stored independently of the other containers stored, and more particularly should enable the container grasping mechanism 14 sufficient room to access the upper portion of each container 1, which is the portion of the containers which the grasping mechanism preferable grasps. Consequently, the vertical distance that separates two stacked shelves should be sufficient to permit entry between the shelves of the container grasping mechanism 14 and a container 1 being grasped, so as to allow a container to be freed and gripped or grasped.

The container storage area 10 preferably includes a sub-frame 18, including a floor 19, which is located above the semiconductor wafer processing tools 3, 4, pillars 20 that support the floor 19 and extend to and rest on the ground, and an upper portion to which are fastened the shelves 16 globally resting on the sub-frame 18. Alternatively, and depending upon the wafer fabrication facility and the arrangement of the tools, the floor and sub-frame may be supported without the necessity of pillars, by suspending or hanging from the ceiling or walls of the facility itself. This approach may be preferable where pillars can interfere with access to the tools.

The floor 19 mounted in its frame, the pillars 20, if used, and the upper portion 22 of the sub-frame 18 are constructed, for instance, of machine-welded tubular metal sections. The floor 19 itself is preferably constructed of openwork or punched sheets to enable air to circulate vertically through it. The floor 19 also preferably includes a free area 21, which extends along the shelves 16 and the row 2 rearwardly of the back of the plane 17 of support shelves 16, as represented in FIGS. 3 and 4, to enable an operator to circulate freely. The sub-frame 18 may be designed and manufactured according to known mechanical rules for building structures to be able to support at least its own weight, the weight of the container transfer mechanism 13 and temporary support 12, the weight of a number of containers full of wafers equalling the maximum capacities of the storage area and support of the containers, as well as the weight of one or more operators in the free area 21, as desired. The free area 21 will preferably include a vertical access, for instance a ladder 26, and conventional safety gates 27, as represented in FIGS. 3 and 4.

The upper portion 22 of the sub-frame 18, which provides a support structure for the shelves 16 and the container transfer mechanism 13, as more particularly represented in FIG. 1, may take the form of an open parallelepipedal framework formed by edges 23 of a parallelepiped and vertical and/or horizontal intermediate strengthening bars 24. The upper portion is preferably arranged so that it does not hinder access to the shelves 16. The sides 25 of the parallelepiped that are not used to access stored containers 1, i.e. the end sides of the row 2 and the top, can be enclosed by safety sheets. The wafer processing tools 3, 4 are preferably located along the row 2 between the pillars 20 of the sub-frame 18 and below the floor 19, as represented in FIG. 1. The front faces of the tools in which the wafer loading/unloading openings 7 are present are preferably situated in the vertical plane 8 approximately defined by the pillars 20 and the outer sides of the vertical edges 23 of the parallelepiped that defines the upper portion 22 of the sub-frame 18.

The sub-frame 18 should be capable of supporting the row conveyor 9, which is located above the processing tools 3, 4 and is substantially parallel to the vertical plane 8. This may be accomplished by means of one or several conventional mounting brackets 28, preferably fastened to one or several vertical edges of the upper portion 22 of the sub-frame 18 at selected locations.

The temporary support 12 preferably consist of two shelves 12a, 12b, which preferably adjoin the vertical plane 8 on the sub-frame 18, preferably approximately at the level of the floor 19, and that protrude outward from the plane 8 as represented in FIG. 1. The shelves 12a, 12b are preferably horizontal and each has a maximum area approximately corresponding to the base area of a container 1, in order to minimize additional bulk resulting from the provision of the temporary support. One support 12a is preferably allocated to receive containers from row conveyor 9, and the other support 12b is preferably devoted to the departure of containers on the row conveyor. It should be noted that the allocation of “departure” or “arrival” status to each support 12a, 12b may be reversed, as desired. Alternatively, in the case of a storage system of relatively short length in the X-direction, for instance a system including only one or a few wafer processing tools, each temporary support can advantageously consist of a removable drawer along the Y-axis, according to any known means of removable drawer type, i.e., perpendicularly to the vertical plane 8 having the openings 7. The storage system should then include a drive mechanism for each removable drawer, for instance a motorized drawer drive, so that the latter can assume a first “pulled position” protruding from the front face as represented in FIG. 1, and a second “shut position” (not shown) in which the temporary support 12 does not protrude from the front face 5, 6 of the processing tool or tools 3, 4 and therefore does not hinder or obstruct access to the openings 7 by the container transfer mechanism from above, even if the temporary support 12 is situated above the openings.

Preferred embodiments of the container transfer mechanism 13 are more particularly described hereunder, with reference to FIGS. 5 to 9. In one embodiment particularly represented in FIGS. 5-7, the drive 15 for the container grasping mechanism 14 has three degrees of freedom in translation corresponding substantially to three perpendicular directions X, Y and Z in space. Accordingly, the container transfer mechanism 13 preferably comprises a first guide 29, which is substantially parallel to the row 2, and which is preferably mounted to the sub-frame 18. The first guide advantageously provides the container grasping mechanism 14 one degree of freedom in translation in the X-direction. The container transfer mechanism also preferably comprises a second guide 30, which is linked to the first guide 29, and which is free in translation on the first guide substantially in the Z-direction, thus providing the container grasping mechanism 14 a degree of freedom in translation substantially in the Z-direction. The container transfer mechanism 13 also preferably comprises a trolley 31, which bears the container grasping mechanism 14, and which is linked to the second guide 30 and is free in translation on the second guide. Preferably, the container grasping mechanism 14 is connected to the trolley 31 by a link having a degree of freedom in translation in the Y-direction, and a degree of freedom in translation in the Z-direction. The degree of freedom in the Z-direction is preferably provided by a vertical elevator system 36, which enables the container grasping mechanism 14 to be lowered and raised to access an area located beneath the trolley, and more particularly beneath the lower limit of the second guide 30.

The vertical elevator system 36 preferably comprises a motor driven winch 54 coupled to a telescopic device 37, which is described in further detail below. A plurality of belts or cables 56, three being shown in the exemplary embodiment of FIG. 5, are wound around the spool of the winch 54. At one end, the cables support a lower portion of the container grasping mechanism 14 that physically engages and grasps containers 1. Preferably the motor driven winch 54 is computer controllable to selectively raise and lower the container grasping mechanism to raise and lower containers 1 in the Z-direction. The cables preferably support routing of power and control/command lines to the lower portion of the container grasping mechanism to enable its selective activation. Thus, when the cables are completely wound on the spool, the lower portion of the container grasping mechanism preferably adjoins the vertical elevator system, and when the cables are unwound the lower portion of the container grasping mechanism hangs beneath the vertical elevator system and can set or retrieve a container 1 before a wafer loading/unloading opening 7 of a wafer processing tool 3, 4, on a shelf 16, or on a tray of temporary support 12.

Alternatively, the second guide 30, which provides the container grasping mechanism 14 a degree of freedom in translation in the Z-direction, may be directly connected to the sub-frame 18. The first guide 29, which provides the container grasping mechanism a degree of freedom in translation in the X-direction, would then be free in translation along the second guide when mounted thereto (not shown).

Preferably, the length of the first guide 29 is approximately equal to the length of the row 2, and the height of the second guide 30 is approximately equal to the height of the upper portion 22 of the sub-frame 18, so that the motion of the trolley 31 in the X and Z directions enables the container grasping mechanism to access all of the storage shelves 16. The first 29 and second 30 guides may advantageously be in the form of prismatic rails. They are preferably mounted rearwardly of the wafer loading/unloading openings 7 and the vertical plane 8 that includes them, in an area 32 located above the semiconductor wafer processing tools 3, 4 and forward of the storage shelves 16.

In the exemplary embodiment shown in FIGS. 3-5, the two prismatic rails 29 constituting the first guide are fixedly and rigidly fastened between the opposite sides of the front edges 23 of the upper portion 22 of the sub-frame 18 in a horizontal orientation. The two prismatic rails 30 that constitute the second guide are rigidly maintained in a vertical and parallel orientation, thus forming a frame with the first guide, as shown in FIG. 5. The two rails 30 are guided in translation on the horizontal rails 29, according to any known means, for instance a ball-bearing link.

The trolley 31 links the two vertical rails 30 to the horizontal rails 29. In the preferred embodiment, the trolley preferably has the vertical rails 30 fixedly coupled thereto, and is guided in translation on the rails 29 by any known means, for instance a ball-bearing link. Alternatively, however, the rails 29 could be fixedly coupled to the trolley and could be free to move in translation on the rails 30. In the preferred embodiment, the motion of the vertical rails 30 of the frame in the X-direction on the horizontal rails 29 is suitably accomplished according to any known means, for instance by means of a linear motor (not shown), which drives the trolley 31. Similarly, the telescopic device 37, described in detail below, is preferably coupled to the vertical rails 30 via a second trolley mechanism 37c, and is guided along the vertical rails 30 in the Z-direction by any known means, for instance a ball-bearing link. Movement of the telescopic device along the vertical rails 37 is preferably accomplished by any known means, for instance a servomotor and drive belt (not shown), which drive the second trolley mechanism 37c.

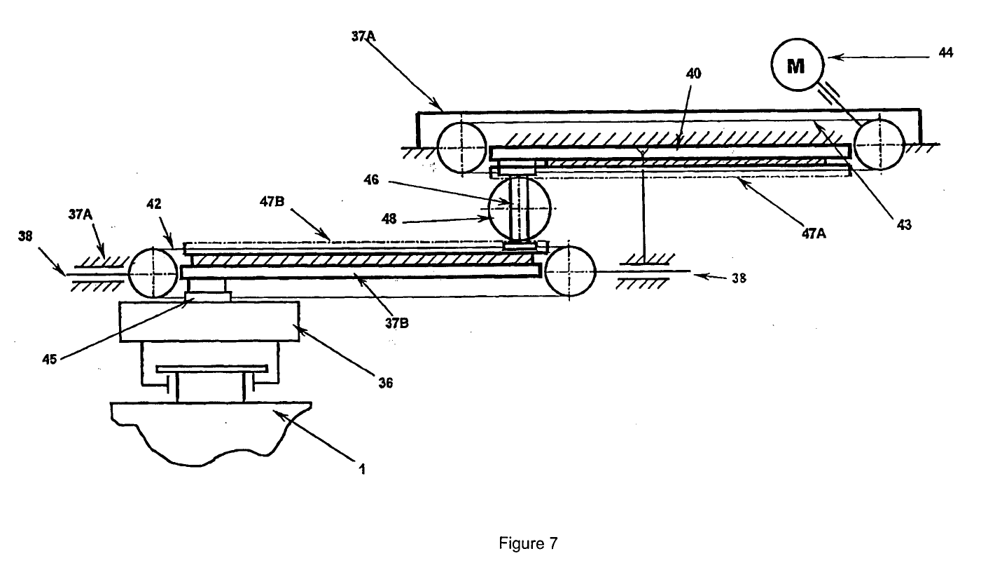

The container grasping mechanism 14 preferably comprises a standard clamping pliers mechanism 35, as shown in FIG. 5 and graphically in FIG. 7, which is suitable to grasp a container 1 by a protrusion on its top, and an elevator system 36, which is operable to move the pliers 35 in the Z-direction. The pliers 35 and the elevator system 36 are preferably linked to the trolley 31 by any means allowing a degree of freedom in the Y-direction, for instance the telescopic device 37 identified above, which provides the pliers 35 and the elevator system 36 a degree of freedom in the Y-direction, as shown in FIGS. 5, 6A, 6B and 7. It should be noted that when a container 1 is held by the pliers 35 and when the pliers are brought to the top position, in which the pliers 35 are adjacent the telescopic device 37, the telescopic device 37 is preferably operable to move the container 1 in the Y-direction on both sides of the rails 30. When the telescopic device 37 is extended rearwardly of the rails 30, the container grasping mechanism 14 is operable to release or grasp a container placed on a shelf 16 in the container storage area. When the telescopic device 37 is extended forwardly of the rails 30, the container grasping mechanism is operable to release or grasp a container 1 placed adjacent a wafer loading/unloading opening 7 or on the temporary support 12.

The clamping pliers mechanism 35 may be constructed in any suitable fashion. Preferably the clamping pliers mechanism 35 will be constructed to enable grasping containers conforming with SEMI standard E47.1, which specifies the structure of a top handling flange. One suitable solution is to have the two jaws of the pliers moved by electromagnets in order to clamp and release the flanges of the mushroom-shaped top handling flange of the container. The clamping pliers mechanism is preferably controlled by the main system controller, which also controls the other container transfer mechanism components, in order to provide selective grasping and releasing of containers.

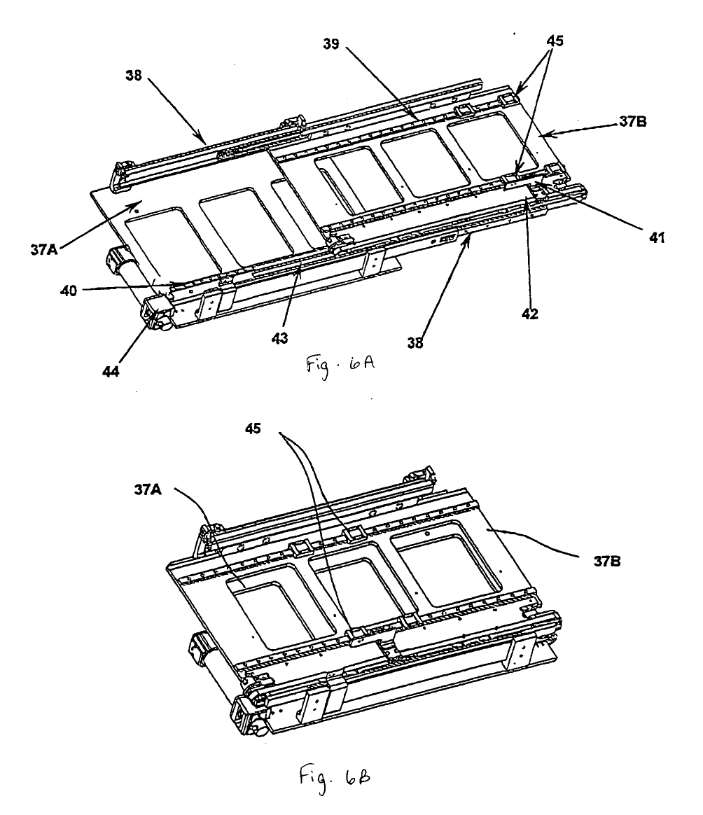

The telescopic device 37 is a subsystem the operation of which is preferably based on translational motions in the Y-direction. In a preferred embodiment, the device may comprise two plates 37A, 37B, which are linked by telescopic guide rails 38. The two plates can be extended in either of two directions Y+ and Y− relative to the guide rails 38. Additional guide rails 39 mounted on a first plate 37B contain one or several pads 45 onto which the container grasping mechanism 14 is preferably fastened, and more particularly the elevator system 36 of the container grasping mechanism, as shown in FIGS. 5, 6A and 6B. The second plate 37A is preferably connected to the drive 15, and more particularly to the trolley 31, preferably by a suitable bracket or the like. The first plate 37B preferably moves relative to the second plate 37A by means of a cogwheel 48 that rotates between racks 47A and 47B on respective plates 37A and 37B, as shown in FIG. 7. The cogwheel 48 is preferably driven about its axis of rotation by a first belt 43 such that the motion of the first plate 37B is approximately twice the motion of the cogwheel 48. The pads 45 are movable in the Y-direction relative to the first plate 37B via a first interface component 41, which is interconnected with and driven by a second belt 42. The second belt is in turn connected to the first belt 43 through a second interface component 46, which is guided in translation on rails 40 mounted on the second plate 37A, as shown in FIG. 7. A motor 44 preferably drives the first belt 43 in rotation in order to move the plates such that the clamping pliers 35 and the elevator system 36 are moved in the Y-direction to a point above a selected loading/unloading opening 7, or shelf 16. From that point, the elevator system can then lower and raise the clamping pliers 35 to clamp or release a container adjacent the selected loading/unloading opening 7 or on the selected shelf 16. The motor and belt may also preferably move the plates of the telescopic device 37 to an intermediate position in which the telescopic device is in a particularly compact contracted form in relation to the Y-axis, with the plates 37A and 37B being stacked one above the other, and the pads 45 being in the middle of the plates in the Y-direction. In this intermediate contracted position, the telescopic device 37 is compact enough to enable it to be moved within the sub-frame 22 between the shelves 16 and the plane 8 at the base of the loading/unloading openings 7. In its extended position, it can reach both the vertically arranged shelves 16 and the position necessary to supply wafer containers to the loading/unloading openings 7. It should be noted that the rack-based drive arrangement may be substituted for, for instance by an additional belt drive (not shown).

In FIGS. 5 and 6A, the telescopic device 37 is shown in its extended position extended in the Y-direction. In FIG. 6B, the same telescopic device is represented in its intermediate compact position as described hereinabove. In FIG. 7 the telescopic device is shown in its extended position.

As described above, the elevator system 36 for moving the clamping pliers in the Z-direction may be provided by any suitable means, and particularly by means of a cable lift, as shown in FIG. 5. It should be noted that, when the pliers 35 are located at the base of the openings 7 of the tools 3, 4, the function of the container transfer mechanism 13 (via the elevator system 36) is similar to the function of the row conveyor 9 that, due to its lift (not shown), enables it in particular to release or to grasp a container 1 at these same openings.

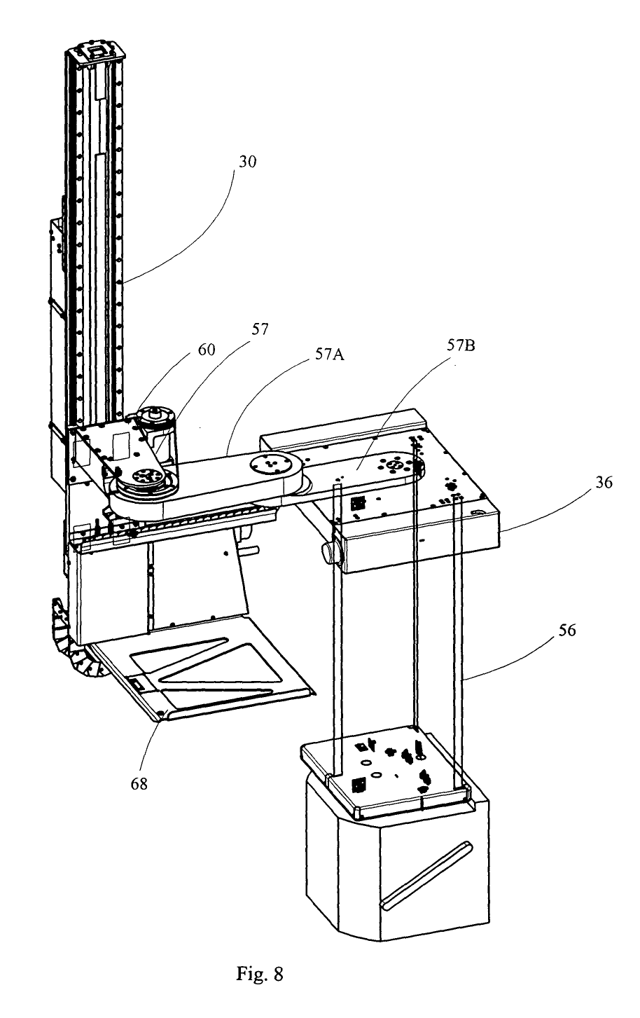

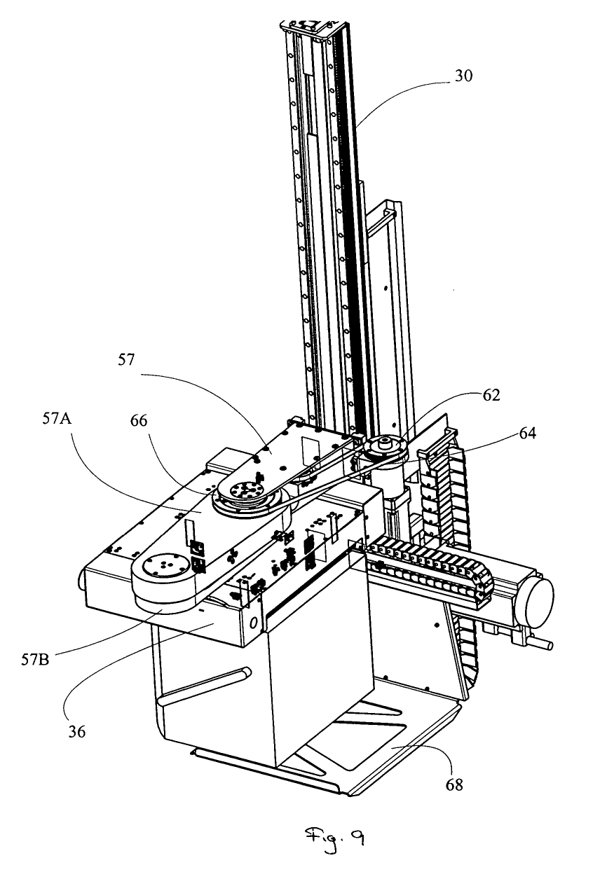

FIGS. 8 and 9 illustrate an alternative preferred embodiment of a mechanism for grasping and conveying wafer containers. In this embodiment, the telescoping device 37 is replaced by a translating device 57, which comprises a pair of rotationally interconnected linear arms 57A and 57B. At an outer end, outer arm 57B is connected to elevator 36, which has belts or cables 56 and a winch system, as previously described, for raising and lowering a container grasping mechanism 35, also previously described, to vertically access and convey a wafer container. At its inner end, outer arm 57B is rotationally connected to an outer end of inner arm 57A. The two arms are preferably overlapping or interleaved so that they can be rotated relative to each other such that arm 57B can be placed in a retracted position tucked beneath arm 57A (as in FIG. 9), and such that the arms can be positioned in a linearly extended position (as in FIG. 8). The inner end of inner arm 57A is rotationally connected to a mounting mechanism 60, which in turn is coupled to guide 30 for movement in translation along guide 30, in a manner previously described with respect to the telescoping device 37. Many suitable rotational interconnections are known to those skilled in the art and detailed description thereof is therefore unnecessary. However, it is preferred that the rotational interconnection selected will be suitable for use in the clean environment of a wafer fabrication facility. As best shown in FIG. 9, a motorized drive system is provided to rotationally drive the arms relative to each other. The drive system preferably comprises a drive motor 62, such as a high precision, digitally-controlled stepper motor, and suitable belts 64 and pulley wheels 66 concentric with the rotational connection points to interconnect and rotationally drive the arms 57A and 57B relative to each other. By making the arms substantially the same length and using different size pulley wheels, for example, the rotation of the arms can be synchronized and they can be caused to rotate relative to each other from the retracted position to the extended position, and vice versa. Alternatively, separate drive motors and belts can be used to rotationally drive each of the rotational interconnections and accomplish the same result. If desired or necessary, due to the weight of the wafer containers and the materials chosen to implement the arms, a wafer container support platform 68 may be provided to support a wafer container while it is being conveyed by the container transfer mechanism.

The container transfer mechanism 13 is thus able to perform tasks previously devoted to the row conveyor 9. The preferred container transfer mechanisms described accordingly provide considerable flexibility to the device according to the invention, and is an appreciable time-saver, since the containers 1 can be moved more quickly by the transfer mechanism 13 than by the row conveyor 9.

The described system for conveying and storing semiconductor wafer containers 1 is preferably managed by a central computer (not shown), which is conventionally programmed and includes system pilot software. The system pilot software serves as an interface for an operator, and enables a determined piloting of the transfer mechanism according to the needs of the wafer processing tools, i.e., allows the operator to command the motion and operation of the container grasping mechanism, and more particularly the motors corresponding to motion of the mechanism in the three X, Y and Z directions, as well as the elevator system. To this effect, the system also preferably includes container presence sensors (not shown) associated with each space of the container storage area and the temporary container support, so that it is known by the central computer at any time which spaces are free and which are occupied. Of course, the system may be programmed to operate automatically also, based on system pilot programming software, which may be customized according to the specific needs of the particular fabrication facility in which the system is installed.

The exemplary system for conveying and storing semiconductor wafer containers 1 as shown in the figures operates in the following way:

The row conveyor 9 supplies the row with containers 1. The conveyor sets the containers one by one on the entry portion of temporary support 12, or directly on supports at the openings of the tools located at the base of the conveyor's lift (not shown).

If the container is set on the entry portion of the temporary support 12, the container is then gripped by the grasping mechanism 14 of the transfer mechanism 13. The drive for the transfer mechanism is activated to move the transfer mechanism 13 to first place the grasping mechanism 14 immediately above the container to be grasped, employing a combination of controlled motions in the X, Y and Z directions described above. The grasping mechanism is then activated to grasp the container and the transfer mechanism again employs a combination of motions in the X, Y, and Z-directions to convey the grasped container and to set it down on a storage space on the shelves 16, where it waits to be assigned to a specific processing tool. When the processing tool to which the container is allocated allows it, the drive for the transfer mechanism is again activated to move the transfer mechanism and grasping mechanism to retrieve the container from the storage area, and to convey the container using a combination of motions in the X, Y and Z directions to a desired position above the assigned tool. The elevator system 36 is then activated to lower the pliers and the grasped container to the opening associated with the allocated tool. The entry portion of the temporary support is thus freed to receive another container from the row conveyor. Alternatively, the container may be set down directly on the entry portion of the temporary support 12 by the row conveyor 9 and may then be grasped and directly conveyed to an opening of the intended tool. From the opening, the container may be conveyed to the departure portion of the temporary support 12 or may be conveyed to a storage space on the shelves 16.

If the container is directly set down at an opening of a tool by the row conveyor, once the semiconductor wafers in the container are processed in the tool, the container may either be directly retrieved by the row conveyor or it may be grasped and conveyed by the transfer mechanism to a storage space on the shelves 16 or to the departure portion of the temporary support 12. This is done as previously described by activating the drive for the transfer mechanism to move the transfer mechanism and grasping mechanism in the desired combination of X, Y and Z directions, and by activating the elevator system 36 to raise the pliers 35 and the grasped container from the opening 7 of the tool. The retrieved container may then wait to be newly allocated to another tool in the row, or may be grasped by the row conveyor, respectively.

It should be noted that the structure of the exemplary system, as described with the aid of FIGS. 1 to 5, enables the grasping mechanism 14 of the transfer mechanism 13 to physically access a container located at any location where the system can hold a container, i.e., to access the storage shelves 16 above and rearwardly of the back of the openings of the tools, the entry and departure portions of the temporary support 12, the openings 7 of the tools of the row, and to move a container that is situated in any of these locations to any other of these locations. However, if desired, the system pilot software loaded in the central computer can limit, according to the needs, and particularly according to the type of tool in the row, the motion of the grasping mechanism to only some of the locations. For example, the software may be configured to exclude the grasping mechanism from accessing the temporary support 12 locations, and may reserve access to the temporary support locations to the row conveyor only.

A preferred embodiment of a system for conveying and storing wafer containers in a row of tools in a wafer fabrication facility has been described. The system is exemplary in nature and is not intended to limit the scope of the invention. Persons skilled in the art will observe that many substitutions of materials, structures, and operations may be made to the described exemplar without departing from the spirit of the invention and while retaining the advantageous characteristics thereof. The scope of the invention is therefore intended to be defined by the scope of the appended claims.

What is claimed is:

1. In a semiconductor wafer fabrication facility having a row including at least one semiconductor wafer processing tool, said tool having a substantially vertical face with an opening for loading and unloading wafer containers, and a row conveyor located above and substantially parallel to said vertical face for supplying wafer containers to said opening, a system for conveying and storing semiconductor wafer containers, comprising:
a storage structure having a storage area for a plurality of said containers and being located above and rearwardly of said opening;
a temporary support for at least one container, said temporary support protruding from said vertical face of said tool and located beneath said row conveyor in such a way as to keep the area above said opening free of obstruction;
a first transfer mechanism selectively operable to move said containers between said temporary support and said storage area;
a second transfer mechanism selectively operable to move said containers between said storage area and said opening; and
a third transfer mechanism selectively operable to move said containers between said temporary support and said opening.

2. The system of claim 1 wherein said storage structure includes a plurality of shelves in said storage area located above said tool and rearwardly of said vertical face.

3. The system of claim 2 wherein said shelves are arranged in a plurality of vertically stacked levels and extend substantially the entire length of said row.

4. The system of claim 3 wherein said storage structure comprises:
a frame including a floor, said floor being supported above said tool;
a subframe located within an upper portion of said frame above said tool and supporting said plurality of shelves; and
said floor having a free area extending along said shelves and said row thereby permitting an operator to move freely in said storage area.

5. The system of claim 4 wherein said floor includes means for allowing vertical air circulation.

6. The system of claim 1 wherein said first, second and third transfer mechanisms are integrated in a single mechanism further comprising:
a container grasping mechanism coupled with said transfer mechanism; and
a drive coupled with said transfer mechanism and operable to selectively move said container grasping mechanism in three directions in space between said opening, said storage area, and said temporary support.

7. The system of claim 6 wherein said drive has at least three degrees of translational freedom comprising three mutually perpendicular directions X, Y, and Z.

8. The system of claim 7 wherein said transfer mechanism comprises:
a first guide parallel to said row defining a degree of translational freedom in said X-direction;
a second guide providing a degree of translational freedom in said Z-direction; and
a trolley guided by said first and second guides, said means for grasping being linked to said trolley by a link having a degree of translational freedom in said Y-direction.

9. The system of claim 8 wherein said second guide is freely translatable on said first guide.

10. The system of claim 9, wherein said first guide has a length approximately equal to the length of said row, and wherein said second guide has a height approximately equal to the height of said subframe.

11. The system of claim 10 wherein said first and second guides are located rearwardly of said opening and forwardly of said shelves above said tool.

12. The system of claim 11 wherein said means for grasping are also linked to said trolley by a vertical elevator that enables the means for grasping to access an area located beneath said trolley.

13. The system of claim 12, wherein said link having a degree of translational freedom in said Y-direction enables said container grasping mechanism to freely translate in said Y-direction on both sides of said first and second guides.

14. The system of claim 1 comprising:
means for moving said temporary support to clear the area located above said opening from obstruction.

15. The system of claim 14 wherein said means for moving said temporary support includes means for moving said temporary support in a Y-direction between a first position wherein said temporary support protrudes from said vertical face of said tool and a second position wherein said temporary support does not protrude from said vertical face of said tool.

16. A transfer mechanism for containers in a system for conveying and storing semiconductor wafer containers in a semiconductor wafer fabrication facility having a row including at least one semiconductor wafer processing tool, said tool having a substantially vertical face with an opening for loading and unloading wafer containers, said system including a row conveyor located above and substantially parallel to said vertical face for supplying wafer containers to said opening, a storage area for said wafer containers, and a temporary support for at least one of said wafer containers, said transfer mechanism comprising:
a grasping mechanism operable to grasp a said wafer container;
a drive mechanism coupled to said grasping mechanism and operable to move said grasping mechanism in X, Y, and Z-directions in space between said wafer loading and unloading opening, said storage area, and said temporary support; and
an elevator coupled to said grasping mechanism and operable to lower and raise said grasping mechanism to access and retrieve a said wafer container.

17. The transfer mechanism of claim 16 wherein said drive mechanism has three degrees of freedom in translation following said X, Y, and Z-directions, and wherein said X-Y, and Z-directions are mutually perpendicular.

18. The transfer mechanism of claim 17, further comprising:
a first guide substantially parallel to said row and corresponding to said degree of freedom in the X-direction;
a second guide corresponding to said degree of freedom in the Z-direction;
a trolley coupled with said grasping mechanism via a link and guided in translation on said first or second guides, said link having a degree of freedom in translation along said Y-direction.

19. The transfer mechanism of claim 18 wherein said second guide is coupled to and free to translate on said first guide.

20. The transfer mechanism of claim 19 wherein said vertical elevator is coupled with said trolley and is operable to lower said grasping mechanism to access an area below said trolley.

21. The transfer mechanism of claim 19 wherein said link is operable to permit movement of said grasping mechanism in said Y-direction on both sides of said first and second guides.

22. The transfer mechanism of claim 21 wherein said link includes a telescoping device comprising a first plate coupled to said drive mechanism, a second plate coupled to said first plate by a second link having at least one degree of freedom in translation corresponding to said Y-direction, and including a plurality of pads free in translation corresponding to said Y-direction in relation to said second plate, said grasping mechanism being coupled to said pads.

23. The transfer mechanism of claim 22, further comprising a belt-drive mechanism coupled to said second plate and said plurality of pads corresponding to said Y-direction.

24. The transfer mechanism of claim 21 wherein said link comprises:
a pair of arms;
a rotational connection between adjacent ends of said arms; a drive mechanism to cause said arms to rotate relative to each other between a retracted position and an extended position in which said arms provide said movement of said grasping means in said Y-direction.
